(19) United States
(12) Patent Application Publication
(10) Pub. No.: US 2018/0221980 A1
(43) Pub. Date: Aug. 9, 2018

(54) METHOD FOR INSPECTION OF THE WELDABILITY OF A PRESSURE-DIE-CAST, ESPECIALLY VACUUM-ASSISTED PRESSURE-DIE-CAST COMPONENT

(71) Applicant: KSM Castings Group GmbH, Hildesheim (DE)

(72) Inventor: Markus ZBOJNIKOWSKI, Hildesheim (DE)

(73) Assignee: KSM Castings Group GmbH, Hildesheim (DE)

(21) Appl. No.: 15/888,189

(22) Filed: Feb. 5, 2018

(30) Foreign Application Priority Data
Feb. 6, 2017 (DE) 10 2017 102 231.7

(51) Int. Cl. B23K 9/095; B23K 9/02

(52) U.S. Cl. CPC B23K 9/0956; B23K 9/02

(57) ABSTRACT

A method for nondestructive inspection of the weldability of a component manufactured by pressure-die-casting, especially by vacuum-assisted pressure-die-casting component, from an aluminum alloy. Using a TIG welding machine, a weld seam of specified length is produced, in an automated process with welding parameters to be predetermined and maintained constant, on the component. The surface of the component is then assessed visually for weldability on the basis of specified features.

### CROSS REFERENCE TO RELATED APPLICATIONS

Applicant claims priority under 35 U.S.C. § 119 of German Application No. 10 2017 102 231.7 filed Feb. 6, 2017, the disclosure of which is incorporated by reference.

### BACKGROUND OF THE INVENTION

### 1. Field of the Invention

The invention relates to a method for nondestructive inspection of the weldability of a pressure-die-cast, especially vacuum-assisted pressure-die-cast component, especially of an aluminum alloy. The invention also relates to a welding system for performance of the method.

### 2. Description of the Related Art

The manufacture of components in the pressure-die-casting or vacuum-assisted pressure-die-casting method is sufficiently known to the person skilled in the art.

### SUMMARY OF THE INVENTION

The task underlying the invention is to provide a method, which has a great repetitive accuracy, for nondestructive inspection of the weldability of a pressure-die-cast component, especially of a vacuum-assisted pressure-die-cast component, especially of an aluminum alloy. Moreover, the invention is intended to help to recognize a defective casting process as quickly as possible.

This task is accomplished by a method having the features according to one aspect of the invention. Improvements and advantageous configurations may be inferred from the discussion below.

In the method according to the invention for nondestructive inspection of the weldability of a pressure-die-cast, especially vacuum-assisted pressure-die-cast component, especially of an aluminum alloy, a weld seam of specified length is produced on the component by means of a TIG welding machine in an automated process with welding parameters that can be predetermined and maintained constant. The surface of the weld seam is then assessed visually for weldability on the basis of specified features.

In another aspect, a welding system is provided for performance of the method according to the invention.

### DETAILED DESCRIPTION OF THE PREFERRED EMBODIMENTS

By virtue of the automated welding of a weld seam with welding parameters predetermined and maintained constant, such a method has a great repeatability. Non-weldable components can be reliably identified as well as sorted out and in addition rapidly provide an indication of a defective pressure-die-casting, especially vacuum-assisted pressure-die-casting method. Consequently, no checks due to false identifications of actually weldable components are performed on pressure-die-casting, especially vacuum-assisted pressure-diecasting machines, which have to be shut down for this purpose. Conversely, false identifications of actually non-weldable components do not lead to any defectively welded final products. The visual assessment of the weld seam permits conclusions about the gas content in the component and thus about the weldability of the component.

The method according to the invention may positively influence in-house workflows and accelerate the production release of the components. By virtue of the automation and of the absent false identification of the components, the method according to the invention is particularly economical.

The tungsten-inert-gas welding, abbreviated TIG welding, by means of a TIG welding machine, is known to the person skilled in the art. Therein an electric arc burns between a non-consumable tungsten electrode and the component. The arc is extremely intensive and can be guided very stably. A separately fed shield gas shields the arc and the, weld zone from the ingress of the atmosphere.

The weld seam is preferably produced at a place of the component not relevant for the further use of the component.

For reliable identification of non-weldable components, it may be of advantage when the distance from the electrode of the TIG welding machine to the surface of the component is predetermined as a welding parameter and maintained constant during the welding. The constant maintenance of the distance may be achieved in particular by a device that continuously senses the surface of the component during welding and, for setting of the distance, transmits it to the torch head of the TIG welding machine holding the electrode.

For reliable identification of non-weldable components, it may be of advantage when the angle between the longitudinal axis of the torch head or of the electrode of the TIG welding machine and the surface of the component is predetermined as a welding parameter and maintained constant during the welding.

For reliable identification of non-weldable components, it may be of advantage when the feed rate of the torch head or of the electrode of the TIG welding machine is predetermined as a welding parameter and maintained constant during the welding.

For reliable identification of non-weldable components, it may be of advantage when the angle of the longitudinal axis of the torch head or of the electrode relative to the surface of the component is set to a constant value between 85 and 95°, preferably to 90°.

For reliable identification of non-weldable components, it may be of advantage when argon is used as shield gas during the welding.

For reliable identification of non-weldable components, it may be of advantage when one or more than one component is placed in a component holder, which is designed, in dependence on the respective component geometry, such that the component has an alignment suitable for the welding. Such a component holder also facilitates in particular the exchange of an inspected component by a component yet to be inspected, wherein the latter immediately occupies the alignment correct for the welding.

For reliable identification of non-weldable components, it may be of advantage to manually place the component in the component holder.

For reliable identification of non-weldable components, it may be of advantage when the distance of the electrode to the surface of the component is set to a constant value of 0.5 to 2 mm, preferably of 0.8 to 1.2 mm, particularly preferably of 1 mm.

For reliable identification of non-weldable components, it may be of advantage when alternating voltage with specified amperage is set as a welding parameter on the TIG welding machine and maintained constant during the welding.

For reliable identification of non-weldable components, especially for chassis components, it may be advantageous to set the amperage to 112 amperes or 130 amperes.

For reliable identification of non-weldable components, it may be of advantage when the TIG welding machine is set to an amperage that is selected such that the component heating during welding as well as the burnout and penetration are kept as small as possible, but a fusion depth of at least ½ to preferably ⅔ of the component thickness is achieved, in order especially to prevent a negative influence on the weld-seam quality.

For minimization of the penetration and burnout, it may be advantageous to optimize the amperage per unit time during penetration and burnout by setting of the upslope and downslope parameters on the TIG welding machine. The time for the upslope and downslope may preferably be set first in the upper parameter range and reduced continuously until an appropriate penetration. On the whole, the weld-seam quality can be improved thereby.

Especially in vacuum-assisted pressure-die-casting, the optimum microstructure is located at the center of the cross section of a component. Due to the residual solidification of the component material, an increased porosity and segregation of additives is possible. To ensure an objective method according to the invention, the central core should therefore be advantageously molten, wherein a melting depth of ⅔ of the component thickness has proved advantageous.

For reliable identification of non-weldable components, it may be of advantage when feed rate is set to a constant value of 300 mm/min to 500 mm/min, preferably of 350 mm/min to 450 mm/min, particularly preferably of 400 mm/min.

For reliable identification of non-weldable components, it may be advantageous to produce the weld seam in a length of at least 40, preferably of at least 45 mm, particularly preferably of at least 50 mm. It may be advantageous to produce the weld seam in a length of at most 70 mm, preferably of at most 60 mm, particularly preferably of at most 50 mm. In this way, a negative influence of the penetration and burnout from the inspection result can be ruled out. A weld seam to be assessed as good, especially without crater formation in the penetration, can be achieved.

In principle, the weld seam should be made as short as possible and as long as necessary, in order to arrive at a result as quickly as possible. Thereby malfunction during the pressure-die-casting, especially vacuum-assisted pressure-die-casting method can be achieved more rapidly. In particular, the throughput of the components to be inspected can be increased in this way.

For reliable identification of non-weldable components, it may be advantageous to assess only the central longitudinal portion of the weld seam, preferably a region of 25 mm, with respect to the weldability of the component.

For reliable identification of non-weldable components, it may be advantageous to assess as a feature for a non-weldability of the component a circumferential black crust, especially around the central longitudinal portion of the weld seam.

For reliable identification of non-weldable components, it may be of advantage when a rough surface, especially in the central longitudinal portion of the weld seam, is assessed as a feature for a non-weldability of the component.

For reliable identification of non-weldable components, it may be of advantage when an irregularly extending weld seam, especially over the width of the central longitudinal portion of the weld seam, is assessed as a feature for a non-weldability of the component.

The aforesaid features can be identified quickly and reliably with the human eye. This identification is the preferred type of identification of the features within the scope of the invention.

It may also be of advantage, however, when the visual assessment of a non-weldability of the component is automated by photographing of an image of the produced weld seam by means of a camera system and comparison with features saved in a database.

The invention also relates to a welding system for performance of the method according to the invention.

It may be advantageous to provide a uniaxial linear drive, which guides the torch head over the component. For this purpose, the mechanical drive may take place, for example, via a stepping motor. Preferably, the stepping motor is driven via individual specially selected control elements. As regards a potential contamination in the welding-shop environment, the necessary robustness can be achieved by such a simple construction of the torch-head guide.

For this purpose, it is necessary that a component holder be provided that is pivotable, in order to reach various welding positions.

It may be advantageous to provide a machine controllable via three axes to control the movement of the torch head. The welding system can be constructed advantageously in the manner of a conventional plasma cutting system, wherein the welding machine can be linked via the inputs and outputs with the path control and integrated via a software, such as Win PC-NC, so that a complete activation via the system is possible.

It may be advantageous to provide a sensing mode via which the distance of the electrode or of the torch head to the surface of the component is maintained constant, wherein the Z-axis is zeroed before each welding process and the path to be covered is recalculated.

Hereby the component holder can be configured very simply, since no pivotability but only a positioning of the component is necessary.

It may be of advantage when a component holder is provided for at least one component, wherein the component holder is adapted to the geometry of the component to be inspected, in such a way that the component has an alignment suitable for the automated welding in the welding system.

In order to save changeover times, it may be advantageous when, for components in the chassis sector, each component holder is able to hold a left and right component as viewed in travel direction. The components to be inspected are preferably held at the first holding points. These holding points are relevant for the assurance of the respective equivalent positioning. So that the exchange of the components to be inspected and those components that have been finish-inspected takes place quickly, it may be advantageous if clamping jigs with hand tighteners are provided.

Although only a few embodiments of the present invention have been shown and described, it is to be understood that many changes and modifications may be made thereunto without departing from the spirit and scope of the invention.

What is claimed is:

1. A method for nondestructive inspection of weldability of a pressure-die-cast component comprising
(a) producing a weld seam of specified length on the component in an automated process using a TIG welding machine with predetermined welding parameters maintained constant; and
(b) assessing a weld seam surface of the weld seam Visually for weldability based on specified features.

2. The method according to claim 1, wherein one of the welding parameters predetermined and maintained constant during welding comprises a distance of an electrode of the TIG welding machine to a component surface of the component.

3. The method according to claim 1, wherein one of the welding parameters predetermined and maintained constant during welding comprises an angle between a longitudinal axis of a torch head or of an electrode of the TIG welding machine and a component surface of the component.

4. The method according to claim 1, wherein one of the welding parameters predetermined and maintained constant during. welding comprises a feed rate of a torch head or of an electrode of the TIG welding machine.

5. The method according to claim 3, wherein the angle of the longitudinal axis of the torch head or of the electrode relative to the component surface of the component is set to a constant value between 85 and 95°.

6. The method according to claim 1, wherein argon is used as a shield gas during welding.

7. The method according to claim 1, further comprising:
providing at least one component holder designed in dependence on a respective component geometry of at least one component such that the at least one component has an alignment suitable for welding; and
placing at least one component in the at least one component holder.

8. The method according to claim 7, wherein placement of the at least one component in the at least one component holder is performed manually.

9. The method according to claim 2, wherein the distance of the electrode to the component surface of the component is set to a constant value of 0.5 to 2 mm.

10. The method according to claim 1, wherein one of the welding parameters predetermined and maintained constant during welding comprises a set alternating voltage with specified amperage.

11. The method according to claim 10, wherein the amperage is set to 112 amperes or 130 amperes.

12. The method according to claim 10, wherein the TIG welding machine is set to an amperage that is selected such that component heating during welding as well as burnout and penetration are kept as small as possible while achieving a fusion depth of at least ½ of component thickness of the component.

13. The method according to claim 4, wherein the feed rate is set to a constant value of 300 mm/min to 500 mm/min.

14. The method according to claim 1, wherein the specified length of the weld seam produced is at least 40 mm.

15. The method according to claim 1, wherein the specified length of the weld seam produced is at most 70 mm.

16. The method according to claim 1, wherein only a central longitudinal portion of the weld seam is assessed with respect to the weldability of the component.

17. The method according to claim 1, wherein a circumferential black crust is assessed as a feature for a non-weldability of the component.

18. The method according to claim 1, wherein a rough surface is assessed as a feature for a non-weldability of the component.

19. The method according to claim 1, wherein an irregularly extending weld seam is assessed as a feature for a non-weldability of the component.

20. A welding system for performance of a method for nondestructive inspection of weldability of a pressure-die-cast component, the method comprising producing a weld seam of specified length on the component in an automated process using a TIG welding machine with predetermined welding parameters maintained constant, and assessing a weld seam surface of the weld seam visually for weldability based on specified features.

21. The welding system according to claim 20, comprising a machine controllable via three axes to control movement of a torch head.

22. The welding system according to claim 21, further comprising a sensing mode for maintaining constant distance of an electrode or of a torch head to a component surface of the component, wherein a Z-axis is zeroed before each welding process and a path to be covered is recalculated.

23. The welding system according to claim 21, further comprising a component holder for at least one component having a geometry, wherein the component holder is adapted to the geometry of the at least one component in such a way that the at least one component has an alignment suitable for automated welding.
